(19) United States
(12) Patent Application Publication
(10) Pub. No.: US 2025/0028184 A1
(43) Pub. Date: Jan. 23, 2025

(54) ADAPTIVE FEEDBACK CONTROL OF AN OPTRONIC SIGHT

(71) Applicant: SAFRAN ELECTRONICS & DEFENSE, Paris (FR)

(72) Inventors: Stéphane Richard, Moissy-Cramayel (FR); Serge Hirwa, Moissy-Cramayel (FR); Arnaud Quadrat, Moissy-Cramayel (FR); Boris Vasse, Moissy-Cramayel (FR)

(73) Assignee: SAFRAN ELECTRONICS & DEFENSE, Paris (FR)

(21) Appl. No.: 18/711,867

(22) PCT Filed: Nov. 28, 2022
(86) PCT No.: PCT/FR2022/052184

§ 371 Date: May 20, 2024

(30) Foreign Application Priority Data
Dec. 2, 2021 (FR) 2112838

(51) Int. Cl. G02B 27/64; G02B 23/16

(52) U.S. Cl. CPC G02B 27/644; G02B 23/16

(57) ABSTRACT

The invention relates to an optronic sight (2) for a motorised vehicle such as an aerial, marine or land vehicle, comprising a sighting module (4) able to be moved about a first axis (8a) and a second axis (10) not parallel to the first axis (8a),
means (17a, 17b) for moving the sighting module about the first (8a) and second (10) axes,
means (14) for continuously measuring an angular datum of said module (4) about the first and second axes characterised in that it comprises a feedback control loop comprising:
means for acquiring the fundamental frequency of vibratory disturbances generated by the operation of at least one device of the sight, and
an adaptive corrector (26) configured to receive as input:
   said fundamental frequency,
   a discrepancy between an angular setpoint value (y_{ck}) and said angular datum
   outputting a movement setpoint value to the movement means (17a, 17b).

### TECHNICAL FIELD OF THE INVENTION

The present invention relates to the feedback control of an optronic sight for a motorised vehicle such as an aerial, marine or land vehicle.

### PRIOR ART

Referring to FIGS. 1 and 2, which illustrate an optronic sight and an operating diagram of such a sight according to the prior art, an optronic sight 2 consists of a set of cameras and/or aiming devices, so-called sighting module 4. This sighting module 4 is placed on a support 6 of a motorised vehicle and can move according to two axes 8a, 10. The line of sight 12 of said optronic sight 2 refers to the optical axis originating from one of these sensors. The optronic sight 2 is intended to orient the line of sight 12 towards a target irrespective of the movements of the motorised vehicle and/or of the target, and irrespective of the external environment (atmospheric conditions, etc.). To this end, said sighting module 4 includes means 14 for continuously measuring an angular datum, i.e. a gyrometer in the case of the measurement of the angular speed or a gyroscope for measuring the angular position of the line of sight 12, as illustrated in FIG. 1.

By its movements or its motor speeds, the carrier vehicle generates angular disturbances which deteriorate the stability of the line of sight 12 of the optronic sights 2. It is then necessary to set up a process allowing stabilising the image accurately and therefore in particular correcting the angular datum (angular speed or position) of the line of sight 12 thanks to a corrector 15. Afterwards, this correction is carried out by means of control means 16 of the movement means 17a, 17b which may comprise gimbals actuated by motors.

Hence, to reject the vibratory disturbances acting on the sighting module 4 and thus make the line of sight 12 fixed in an inertial reference frame, the sum of the torques, i.e. the motor torque Cₘₒₜ, the torque due to the disturbances and the friction torque C_{f} due to the bearings of the gimbals, applied to the sighting module 4, should be zero.

For this purpose, it is conventionally known to use a feedback control loop 20 capable of acting on the angular datum (speed or position) of the line of sight 12 as illustrated in FIG. 2. Each block of said feedback control loop 20 may be designed as a system, i.e. a set of relationships relating inputs and outputs which could be set out using transfer functions.

Hence, the feedback control loop 20 is intended to enable the motors to generate a torque Cₘₒₜ which compensates in particular for the friction torque C_{f} at the motorised gimbals to stabilise the angular orientation of the line of sight, when a carrier vehicle on-board the sight moves angularly. We will then talk about a transfer function Hₘₒₜ between a voltage u and a torque Cₘₒₜ. The setpoint u of the motors is generated by the output of a corrector K. An objective of this feedback control loop is to make the output y tend towards a reference y_{ck}, although the motors and gimbals are subject to disturbances due to bearing of the gimbals and to the angular disturbance δ_{y}. The function of feedback control of the line of sight of the optronic sight 2 comprises an analog portion 22 and a digital portion 24. First of all, in the analog portion 22, the spectral lines associated with the disturbing vibrations γ_{vib} generated by the rotation of the rotor and the blades of a helicopter are identified and fixed filters on these spectral lines will subsequently be set up. Thus, the transfer function H_{vib} allows modelling the impact of the disturbing vibrations γ_{vib} on the angular orientation of the line of sight. Hence, at the output of the transfer function, the angular disturbance δ_{y} of the line of sight due to the disturbing vibrations γ_{vib} is obtained which could thus be considered in the feedback control loop of the optronic sight. Hence, this feedback control method is based on a priori knowledge of a model of the studied system.

Afterwards, another one of the steps consists in modelling the dynamics of the measurement of the angular datum (angular position or speed) of the line of sight by a transfer function denoted H_{gyro}. This transfer function is based either on the measurement y of the position of the line of sight by means of a gyroscope, or on the measurement y of the angular speed of the line of sight obtained by a gyrometer or more specifically by the inertial sensor of the gyrometer. Henceforth, the measurement of the angular datum of the obtained line of sight yₘ passes through an Analog-to-Digital Converter (ADC) and is thus sampled to become the sampled measurement yₘₖ. A feedback control error Eₖ is then obtained by the difference between a reference y_{ck} and the sampled measurement yₘₖ. This feedback control error Eₖ then passes as input of a linear and time-invariant corrector K. The latter is calculated in order to compensate for the disturbing vibrations whose fundamental frequency is fixed over time. The software implementation of said corrector K is done in the form of a combination (sum and/or product) of second-order digital linear filters. At the output of this corrector, a digital motor control uₖ is obtained, which is transformed afterwards into an analog control u (voltage) by an Analog-to-Digital Converter (DAC). This analog control u is applied to the electric motor, modelled by the transfer function Hₘₒₜ, which consequently delivers an electromechanical torque. Thus, it allows obtaining the electromechanical torque Cₘₒₜ to be supplied by the motor to rotate the gimbals. The greater the error Eₖ, the higher the torque Cₘₒₜ supplied by the motors should be in order to reduce this error. The electromechanical torque Cₘₒₜ supplied by the motor actuates the gimbals modelled by the transfer function H_{gimbal}, in order to compensate/cancel the error εₖ. This error is due, on the one hand, to the disturbing torque of frictions in the bearings of the gimbals and, on the other hand, to the angular disturbance δ_{y}.

Moreover, the optical sight is generally equipped with at least one integrated cold machine which is intended to cool the sighting module(s). As is the case in particular of the sighting modules that integrate an infrared optical sensor which requires temperature control.

The cold machine also generates sinusoidal disturbances whose frequency varies according to the temperature required to cool the sighting module, which, in turn, depends on the temperature of the external environment.

In the prior art, these disturbances are experienced and are not compensated by the correctors of the feedback control loop.

Hence, the cold machine is also a source of disturbance for the line of sight, whose natural frequency varies.

Hence, the invention aims to provide an optical sight capable of compensating for the disturbances generated by one or more internal on-board disturbance generator(s) that might affect the line of sight.

### DISCLOSURE OF THE INVENTION

Hence, an object of the invention is an optronic sight for a motorised vehicle such as an aerial, marine or land vehicle, comprising:
a sighting module able to be moved about a first axis and a second axis (10) not parallel to the first axis,
means for moving the sighting module about the first and second axes,
means for continuously measuring an angular datum of said module about the first and second axes.

The optical sight further comprises a feedback control loop comprising:
means for acquiring the fundamental frequency of vibratory disturbances generated by the operation of at least one device of the sight, and
an adaptive corrector configured to receive as input:
   said fundamental frequency,
   a discrepancy between an angular setpoint value and said angular datum
   outputting a movement setpoint value to the movement means.

Thus, the adaptive corrector varies according to the frequency of the disturbing vibrations by the operation of an on-board device, such as a cold machine intended for cooling an infrared optical sensor, while guaranteeing the stability of the feedback control loop.

The adaptive corrector may be connected to said device of the sight via a digital communication link on which said fundamental frequency of the vibratory disturbances is transmitted.

Advantageously, the communication link is connected to an electronic control module of said device of the sight delivering the fundamental frequency.

The means for continuously measuring said angular datum may include a gyroscope able to obtain an angular position or a gyrometer able to obtain an angular speed.

The adaptive corrector may be a Linear Parameter-Varying corrector.

This Linear Parameter-Varying corrector is linear but varying over time, according to parameters that can be measured or identified. It depends linearly on the varying parameter.

Said adaptive corrector can follow the state representation according to the following formula:

$$\{ \begin{matrix}{x}_{k + 1} = A ( {\hat{f}}_{vk} ) {x}_{k} + B ( {\hat{f}}_{vk} ) {ε}_{k} \\ {u}_{k} = C ( {\hat{f}}_{vk} ) {x}_{k} + D ( {\hat{f}}_{vk} ) {ε}_{k}\end{matrix}$$

$${f}_{min} \leq {\hat{f}}_{vk} \leq {f}_{max}$$

where xₖ is the state variable of the corrector, εₖ
is the feedback control error at the input of the corrector, uₖ is the digital motor control calculated by the corrector (output of the corrector), fₘᵢₙ and fₘₐₓ are two frequencies limiting the fundamental frequency in real-time \hat{f}ᵥₖ of the disturbing vibrations γ_{maf}.

The Linear Parameter-Varying (LPV) corrector may comprise the following affine state matrices:

$$A ( {\hat{f}}_{vk} ) = {A}_{0} + {\hat{f}}_{vk} {A}_{1}$$

$$B ( {\hat{f}}_{vk} ) = {B}_{0} + {\hat{f}}_{vk} {B}_{1}$$

$$C ( {\hat{f}}_{vk} ) = {C}_{0} + {\hat{f}}_{vk} {C}_{1}$$

$$D ( {\hat{f}}_{vk} ) = {D}_{0} + {\hat{f}}_{vk} {D}_{1}$$

where A₀, B₀, C₀, D₀, A₁, B₁, C₁, D₁ denote matrix gains which are the parameters saved in the memory of a software that implements said corrector. The first axis and the second axis may be perpendicular to each other.

Another object of the invention is a motorised vehicle such as a helicopter, an aerial, marine or land vehicle comprising an optronic sight as defined hereinabove.

### BRIEF DESCRIPTION OF THE FIGURES

FIG. 1 is a schematic view of an optronic sight of the prior art,

FIG. 2 is a diagram showing the operation of an optronic sight in the prior art,

FIG. 3 is a schematic view of an optronic sight according to the invention,

FIG. 4 is a diagram showing the operation of an optronic sight according to the invention,

### DETAILED DESCRIPTION OF THE INVENTION

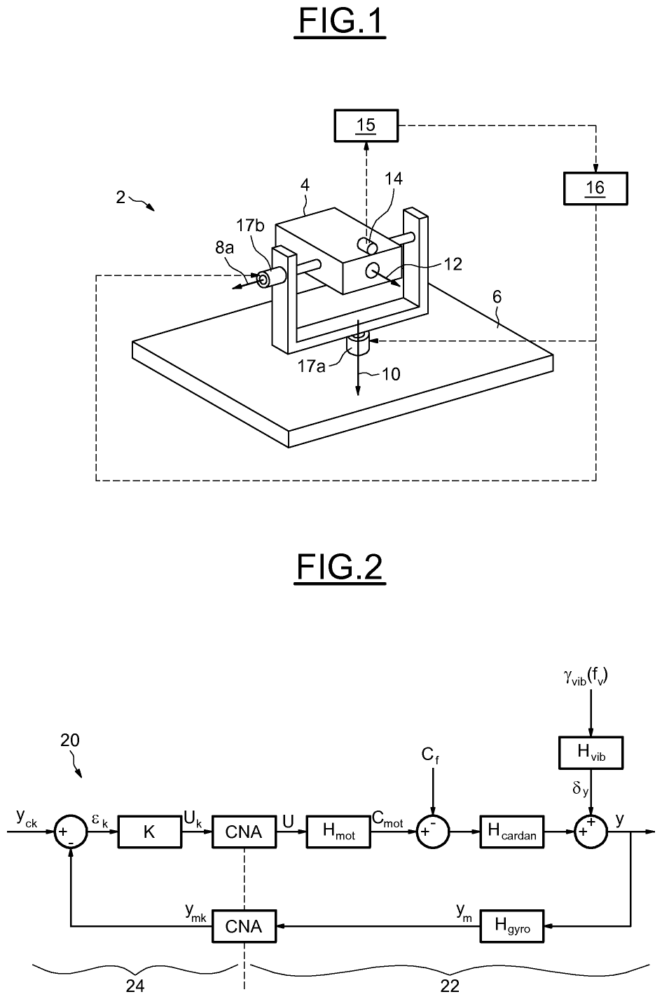

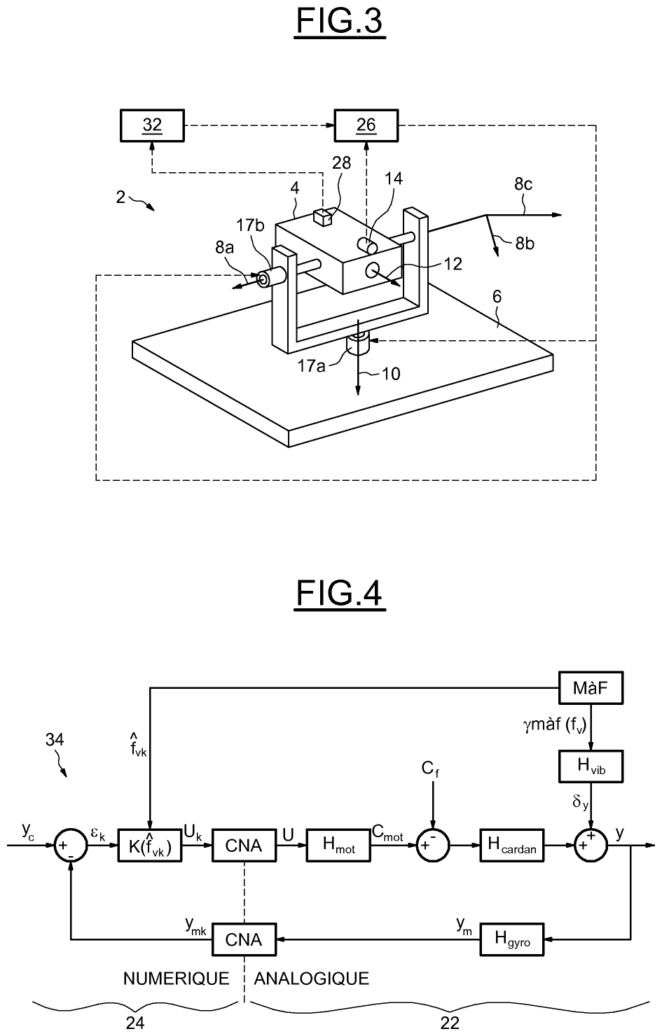

FIGS. 3 and 4, on which elements identical to those of FIGS. 1 and 2 bear the same reference numerals, respectively illustrate a schematic view of an optronic sight 2 and a diagram showing the operation of such a sight according to an embodiment of the invention. In particular, the optronic sight 2 comprises:
a sighting module 4 able to be moved about a first axis 8a and a second axis 10 perpendicular to the first axis,
means 17a, 17b for moving the sighting module 4 about the first 8a and second 10 axes,
means 14 for continuously measuring an angular datum of said module about the first 8a and second 10 axes.

In the embodiment illustrated in the figures, the first axis 8a and the second axis 10 are perpendicular but it should be understood that the details of embodiments given hereinafter are also applicable to embodiments wherein the axes are not perpendicular and even not secant. The first axis 8a and the second axis 10 may also be secant and non-perpendicular.

The embodiment of FIGS. 3 and 4 is intended to feedback control the position of the optical sight on an angular setpoint value ye and to compensate for the vibrations generated during the operation of internal devices on board the optronic sight, whose fundamental frequency is known or can be estimated.

It may consist of any type of device embedded in the sight. Nonetheless, the described embodiment applies to the compensation of the vibrations generated during the operation of a cold machine MaF intended for cooling an infrared optical sensor and the operation of which generates vibrations γ_{maf} (fv) whose frequency varies according to the operating speed of the machine, and therefore according to the temperature of the environment of the machine.

The feedback control of the position of the optical sight uses a measurement of the angular datum of the line of sight obtained either on the basis of the measurement y of the position of the line of sight by means of a gyroscope, or on the basis of the measurement y of the angular speed of the line of sight obtained by a gyrometer or more specifically by the inertial sensor of the gyrometer. Afterwards, the dynamics of the angular datum measurement (angular position or speed) of the line of sight is modelled by a transfer function H_{gyro} and the modelled datum passes through an Analog-to-Digital Converter (ADC) and is thus sampled so as to become the sampled measurement yₘₖ. A feedback control error εₖ is then obtained by difference between one reference ye and the sampled measurement yₘₖ. This feedback control error εₖ then passes as input of a linear and time-invariant corrector K 26.

Moreover, the optronic sight 2 of FIGS. 3 and 4 differs from the optronic sight 2 presented with reference to FIGS. 1 and 2 in that, in the feedback control loop 34 according to the present disclosure, at the input of the corrector K, we find not only the feedback control error εₖ which depends on the sampled measurement yₘₖ of the angular datum but also the fundamental frequency \hat{f}ᵥₖ, varying in real-time, of the disturbing vibrations γ_{maf} of the cold machine.

Hence, the adaptive corrector K(\hat{f}ᵥₖ) 26 is calculated in order to compensate for the disturbing vibrations γ_{maf}(fᵥ) whose fundamental frequency fᵥₖ varies over time according to the operating speed of the device, herein the cold machine, which generates these disturbances. For this purpose, the excitation frequency of the cold machine \hat{f}ᵥₖ, which depends on the speed necessary for cooling of the optical sensor, is supplied to the corrector by an electronic control module 28 of the cold machine via a digital communication link. More specifically, the electronic control module of the cold machine delivers to the corrector an estimate of the fundamental frequency \hat{f}ᵥₖ of the vibration, this estimate could advantageously be estimated on the basis of the operating speed of the machine.

As regards the calculations carried out by the adaptive corrector K(\hat{f}ᵥₖ), three techniques can be used: either by using a Linear Parameter-Varying (LPV) control, or by means of a symbolic corrector, or by a combination of these two types of correctors (LPV and symbolic).

In the case of an LPV-controlled corrector, a minimum state representation of the system K(\hat{f}ᵥₖ) is denoted (A, B, C, D) with A∈ [symbol] ^{n×n}, B∈ [symbol] ^{n×1}, C∈ [symbol] R^{1×n} et D∈ [symbol] . The software implementation in the state form of the adaptive corrector K(\hat{f}ᵥₖ) is done according to the following relationship:

$$\{ \begin{matrix}{x}_{k + 1} = A ( {\hat{f}}_{vk} ) {x}_{k} + B ( {\hat{f}}_{vk} ) {ε}_{k} \\ {u}_{k} = C ( {\hat{f}}_{vk} ) {x}_{k} + D ( {\hat{f}}_{vk} ) {ε}_{k}\end{matrix}$$

$${f}_{min} \leq {\hat{f}}_{vk} \leq {f}_{max}$$

where xₖ∈ [symbol] ⁿ is the state variable of the adaptive corrector, εₖ is the feedback control error at the input of the adaptive corrector, uₖ is the digital control of the movement means calculated by the adaptive corrector (output of the adaptive corrector), fₘᵢₙ and fₘₐₓ are two frequencies limiting the fundamental frequency in real-time \hat{f}ᵥₖ of the disturbing vibrations γ_{maf}. The state matrices (A, B, C, D) are \hat{f}ᵥₖ affine and are written in the form:

$$A ( {\hat{f}}_{vk} ) = {A}_{0} + {\hat{f}}_{vk} {A}_{1}$$

$$B ( {\hat{f}}_{vk} ) = {B}_{0} + {\hat{f}}_{vk} {B}_{1}$$

$$C ( {\hat{f}}_{vk} ) = {C}_{0} + {\hat{f}}_{vk} {C}_{1}$$

$$D ( {\hat{f}}_{vk} ) = {D}_{0} + {\hat{f}}_{vk} {D}_{1}$$

where A₀, B₀, C₀, D₀, A₁, B₁, C₁, D₁ denote matrix gains which are the parameters saved in the memory of a software that implements said corrector adaptive K(\hat{f}ᵥₖ).

Thus, the adaptive corrector K(\hat{f}ᵥₖ) varies directly as a function of the frequency of the disturbing vibrations generated by the on-board device, while guaranteeing the stability of the feedback control loop.

1. An optronic sight for a motorised vehicle such as an aerial, marine or land vehicle, comprising:
a sighting module able to be moved about a first axis and a second axis not parallel to the first axis,
means for moving the sighting module about the first and second axes,
means for continuously measuring an angular datum of said module about the first and second axes characterised in that it comprises a feedback control loop comprising:
means for acquiring the fundamental frequency of vibratory disturbances generated by the operation of at least one device of the sight, and
an adaptive corrector configured to receive as input:
said fundamental frequency,
a discrepancy between an angular setpoint value (yck) and said angular datum
outputting a movement setpoint value to the movement means.

2. The optronic sight according to claim 1, wherein the adaptive corrector is connected to said device of the sight via a digital communication link on which said fundamental frequency of the vibratory disturbances is transmitted.

3. The optronic sight according to claim 2, wherein the communication link is connected to an electronic control module of said device of the sight delivering the fundamental frequency.

4. The optronic sight according to claim 1, wherein the means for continuously measuring said angular datum include a gyroscope able to obtain an angular position or a gyrometer able to obtain an angular speed.

5. The optronic sight according to claim 1, wherein said adaptive corrector comprises a Linear Parameter-Varying corrector.

6. The optronic sight according to claim 5, wherein said adaptive corrector follows a state representation according to the following formula:
$$\{ \begin{matrix}{x}_{k + 1} = A ( {\hat{f}}_{vk} ) {x}_{k} + B ( {\hat{f}}_{vk} ) {ε}_{k} \\ {u}_{k} = C ( {\hat{f}}_{vk} ) {x}_{k} + D ( {\hat{f}}_{vk} ) {ε}_{k}\end{matrix}$$
$${f}_{min} \leq {\hat{f}}_{vk} \leq {f}_{max}$$
where xₖ is the state variable of the corrector, εₖ
is the feedback control error at the input of the adaptive corrector, uk is the digital control of the movement means calculated by the adaptive corrector, fₘᵢₙ and fₘₐₓ are two frequencies limiting the fundamental frequency in real-time \hat{f}ᵥₖ of the disturbing vibrations γ_{maf}.

7. The optronic sight according to claim 5, wherein said Linear Parameter-Varying (LPV) corrector comprises the following affine state matrices:
$$A ( {\hat{f}}_{vk} ) = {A}_{0} + {\hat{f}}_{vk} {A}_{1}$$
$$B ( {\hat{f}}_{vk} ) = {B}_{0} + {\hat{f}}_{vk} {B}_{1}$$
$$C ( {\hat{f}}_{vk} ) = {C}_{0} + {\hat{f}}_{vk} {C}_{1}$$
$$D ( {\hat{f}}_{vk} ) = {D}_{0} + {\hat{f}}_{vk} {D}_{1}$$
where A0, B0, C0, D0, A1, B1, C1, D1 denote matrix gains which are the parameters saved in the memory of said corrector.

8. The optronic sight according to claim 1, wherein the first axis and the second axis are perpendicular to each other.

9. The optronic sight according to claim 1, wherein said device of the motorised vehicle is a cold machine intended for cooling an infrared optical sensor.

10. A motorised vehicle such as an aerial or marine vehicle or land vehicle comprising an optronic sight according to claim 1.
